(19) United States
(12) Patent Application Publication
(10) Pub. No.: US 2004/0243469 A1
(43) Pub. Date: Dec. 2, 2004

(54) System for ensuring information transfer

(76) Inventors: Gerald DeMeyer, Rochester, MI (US); Patrick Gorman, White Lake, MI (US)

Correspondence Address: HARNESS, DICKEY & PIERCE, P.L.C., P.O. BOX 828, BLOOMFIELD HILLS, MI, 48303, US

(21) Appl. No.: 10/799,977

(22) Filed: Mar. 12, 2004

Related U.S. Application Data
(60) Provisional application No. 60/454,404, filed on Mar. 13, 2003.

(51) Int. Cl. G06F 17/60

(52) U.S. Cl. 705/14

(57) ABSTRACT

Provided is a system, which uses product user feedback to ensure that the product user has reviewed product safety or instructional information. The system ensures information transfer from an organization to a customer. The system uses embedded codes within instruction materials and provides a rebate program to ensure proper review of materials by a consumer.

### CROSS-REFERENCE TO RELATED APPLICATIONS

This application claims the benefit of U.S. Provisional Application No. 60/454,404, filed on Mar. 13, 2003. The disclosure of the above application is incorporated herein by reference.

### SUMMARY AND BACKGROUND OF THE INVENTION

The present invention relates to a method of ensuring a customer has reviewed product information, and more particularly to a method of ensuring that a customer reviews safety and warranty information.

Information transfer concerning products is often critical to ensure the proper use of a product. More specifically, information transfer is often required to ensure that a product is not misused. Often this information is provided in the form of information manuals or packets. It is not possible to ensure that the user of a product actually review the instruction manual or at a minimum that product information which ensures that the product or process is not miss used.

In many fields and in many instances this is information that is vital to the safety, well-being and success of individuals, organizations and businesses. This information can quite literally be the difference between success or failure and winning or losing for these individuals or organizations. Unfortunately, often this information has not been imparted to the people that need it before they require it. The results of these situations range from merely disappointing to potentially disastrous.

The information itself can be of a variety of types or forms. It may be specific product usage information, such as users instructions or cautions. It may just be suggestions or ideas on how to get the most out of the product. It could be suggested operating procedures to make the users life better. It may be specific instructions critical to saving a user's life. A nearly limitless variety of possibilities exist.

One area that has sometimes produced problems is the medical field. Medicine cautions and usage have on occasion not been followed with often devastating results. Often the very information that would have prevented a serious problem is contained in the pamphlet accompanying prescribed medicine, the pamphlet that the user neglected to read. While the information for correct usage was provided, the user was not given proper incentive to actually learn the required information.

Many manufacturers offer product rebates. These rebates often require the purchaser to fill out personal information and to send proof of purchase along with an original receipt to obtain their rebate. The majority of the purchasers fill out this paperwork as they are motivated by the cash rebate. It is a widely held belief that a much higher percentage of customers respond to rebate offers than actually read enclosed important product information.

Often, product warnings and use instructions are printed onto the product. Unfortunately, for products having a small size will require that product instructions or warnings be printed on a significant portion of the products. Additionally, often the type font must be significantly reduced so that it reduces the likelihood that the product user will review the safety information. As such, it is an object of the present invention to provide an information transfer information system which will ensure that a product user will have reviewed product safety and product use information.

It is an object of the invention to provide a system which helps ensure that critical information is imparted to the individuals that need the information. The system should document that the individuals knew they needed the information. The system should document that they did in fact review the information. It should also document that they had ample opportunity to make sure they understood the information provided and to also get further clarification if required. The system should also be cost effective and user friendly.

Disclosed is a system, which uses product user feedback to ensure that the product user has reviewed product safety or instructional information. The system ensures information transfer from an organization to a customer. The system uses embedded codes within instruction materials and uses a rebate program to ensure proper review of materials by a consumer.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 represents a flow chart depicting the use of a mail center as applied to the teachings of the present invention;

FIG. 2 represents a flow chart depicting the use of a phone center method using the teachings of the present invention;

FIG. 3 represents the use of a computer network and the application of the teachings of the present invention; and

FIG. 4 represents a sample letter used to effectuate the teachings of the present invention.

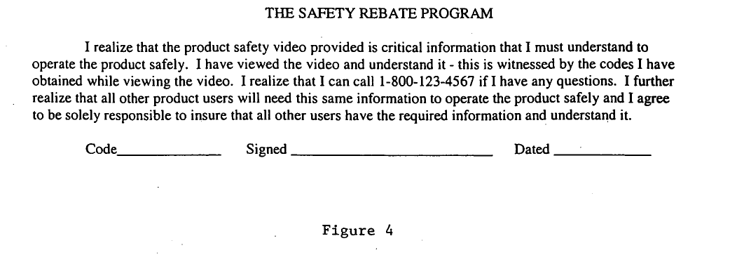

### DETAILED DESCRIPTION OF THE PREFERRED EMBODIMENTS

The following description of the preferred embodiments is merely exemplary in nature and is in no way intended to limit the invention, its application, or uses.

One embodiment of the system calls for the manufacturer of a product to provide key product usage information in one or more media types for the customer's education. The media types can be of any of a wide range including but not limited to written media, video tapes, audio tapes, or computer software just to name a few possible types. Within the various media types at predetermined critical places, codes will be placed for the customers to find. These codes will be needed to fill out the forms as part of a rebate program. The codes may have static values or may be dynamic or changing in nature. In the act of finding the codes the user will be exposed to critical product usage information. The customer will be notified on the rebate form that the information is critical to safe usage of the product. The customer will further acknowledge on the rebate form that he or she has assimilated the required information and that he or she understands the information.

The customer also will be given one or more means to gain clarification of the provided information if in the rare event the information provided is not easily understood. When the customer does fully understand the information he will sign the rebate form and acknowledge that he or she does understand the material. At the choice of the manufacturer, the customer may or may not be required to answer one or more questions to demonstrate understanding of the material. The customer will also acknowledge that if there are to be more users of the product than just himself or herself that they will solely be responsible for insuring that the information is comprehended by all other users of the product.

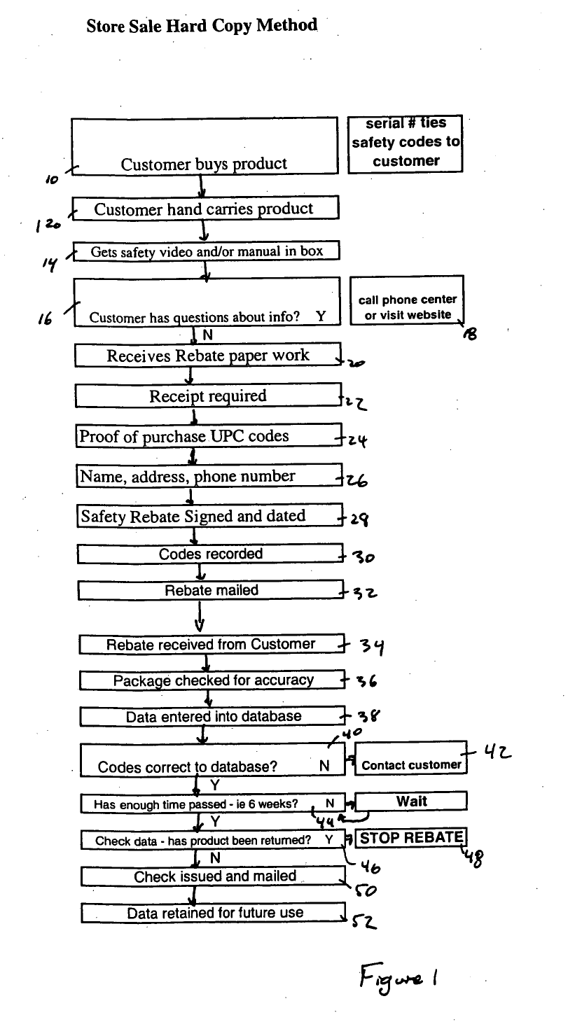

FIG. 1 depicts a flow chart, a mail based rebate system according to the teachings of the present invention. The system begins in process block 10 where a customer buys a product. Upon opening the product, the customer receives safety and rebate information in process block 14 in the form of a video, digital information, or a manual within the product box. In process block 16, the customer is queried as to whether it has additional questions as to the information it received, and is given the opportunity in process block 18 to call an information phone center or visit a website. Should the customer not have any questions in process block 16, the customer will receive rebate paperwork in process block 20.

In process block 26, information such as name, address, and phone number are collected from the customer. Upon reviewing the information, codes which are embedded within the safety information are recorded onto a signed rebate form and the rebate form is mailed to a mail center in process block 32. In process block 34 the rebate information is received from the customer. In process blocks 38 and 40, information from the rebate including serial number and safety codes from the customer are entered into a database. In query block 40, the materials are checked to see if they are correct within the database. Should they not be correct, the customer is contacted in process block 42 and given the opportunity to correct the information. If the codes are correct, a fixed amount of time, for example six weeks, is waited before determining whether the product has been returned to a store in process block 46. If the product had been returned, the rebate is stopped in process block 48. If the product has not been returned, a rebate in the form of a check or a product is mailed to the customer. Additionally, codes can be returned to the customer to enable additional product features. It is envisioned that the data will be retained in process block 52 for future use.

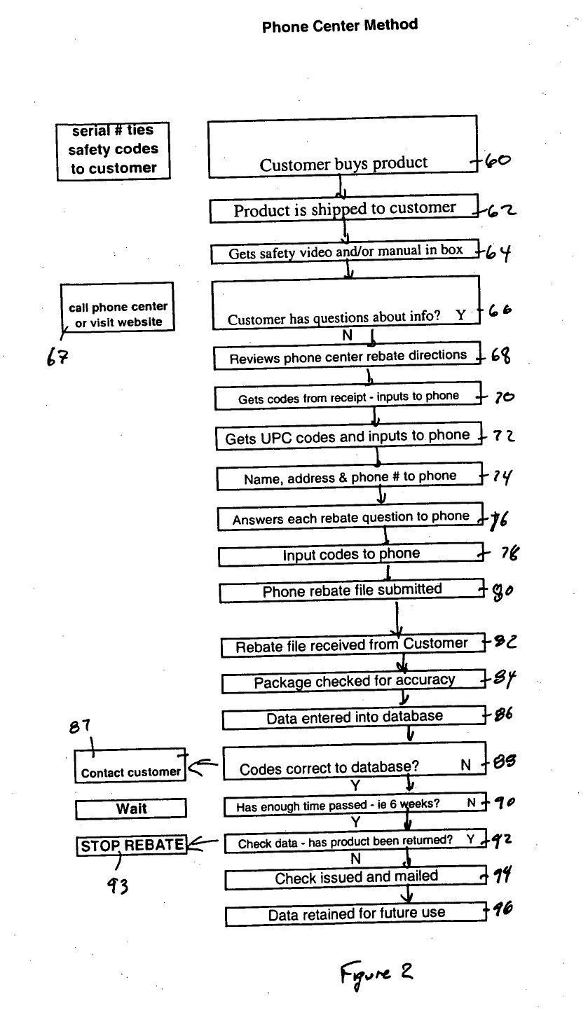

FIG. 2 represents a flow chart depicting the use of a telephone call-in center in the information transfer method according to the teachings of the present invention. In process block 60, a customer buys a product and receives and reviews safety information in the form of a video, electronic data, or a manual which is with the product. In process block 66, should the customer have any questions, the customer is directed to the telephone center or website at process block 67 for further information. In any instance, the customer is directed to a telephone center for rebate directions in process block 68. At this time, the customer inputs codes from the safety information into the phone center using a telephone's key pad touch tone or by the assistance of an operator.

At this point, the customer inputs product information such as a UPC codes into the telephone system as well as name, address, and phone numbers. The customer is then queried as to rebate questions concerning the product and inputs those codes into the telephone system using the telephone's key pad in process block 78. Once all information has been received, the customer then submits a rebate file using a telephone key pad. Once the rebate file is received from the customer, it is checked for accuracy in process block 84 and the data is entered into a database in process block 86. A determination is made if the rebate codes are correct in query block 88. If the codes are not correct, the customer is contacted in process block 87 and given the opportunity to correct the info. If the information is correct, a rebate in the form of a check or product is forwarded to the customer in process block 94.

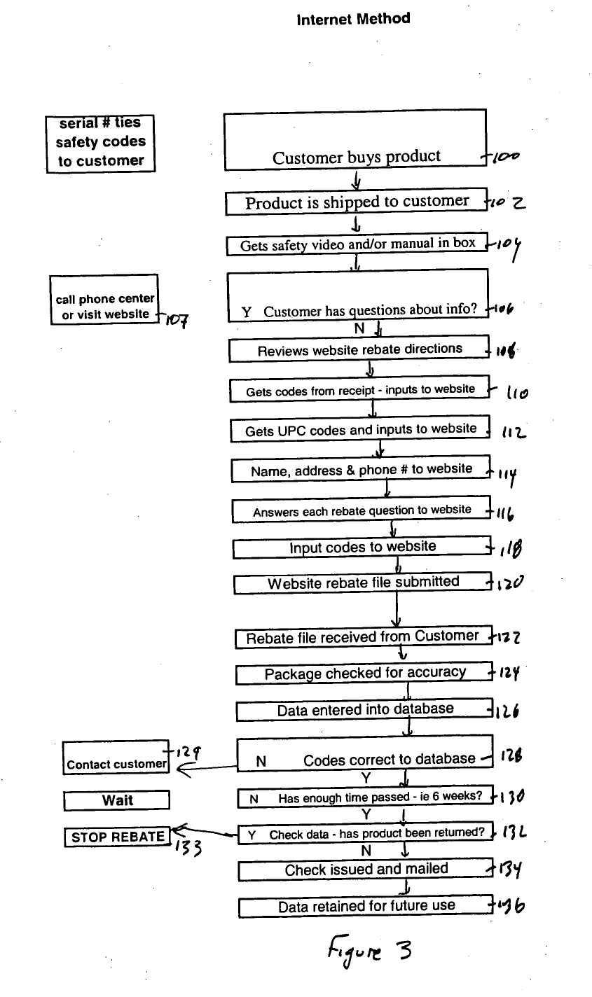

FIG. 3 is a flow chart which represents the use of the internet to collect product information utilizing the teachings of the present invention. The method starts in process block 100 where the customer buys a product. The customer reviews the safety information in the form of a video, the electronic format, or a manual in process block 104. In process block 106, should the customer have questions concerning the safety information, the customer is directed to contact the website or phone center in process block 107. Should the customer not have any questions in query block 106, the customer is directed to the system's website to review rebate directions and instructions. In process block 110, the customer obtains codes from the sales receipt and inputs it into the website. In process blocks 112 and 114, the customer inputs product information such as UPC codes, and name, address, and phone number into the website.

In process block 116, the customer is queried as to a rebate questions concerning information within the safety video and is asked to input those into the website. In process block 118, the customer inputs the information into the website and submits the file to the system. In process block 122, the rebate file is received from the customer and checked for accuracy in process block 124. The data is subsequently entered into the system database and a query is made as to whether the codes are correct in query block 128. Should the codes be incorrect, the customer is contacted in process block 129. In process block 130, a determination is made as to whether enough time has passed and to determine whether the product has been returned. If the product has not been returned, the rebate in the form of a check or product is mailed to the customer in process block 134.

The system described above may be accomplished in more than one way. While rebate form or forms are described above, other alternatives such as completing some or all of the above tasks online at an internet website or by other means not detailed is possible.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of ensuring the transfer of data in instruction material from a first party to a second party comprising the steps of:
providing the second party with a set of instructional materials containing an embedded code;
querying the second party as to the value of the embedded code; and
providing the second party a rebate after a predetermined amount of time.

2. The method according to claim 1 wherein the second party receives the instructional material upon the purchasing of a product.

3. The method according to claim 2 further including determining if the product has been returned prior to providing a second party a rebate, and if it has been return preventing providing a second party the rebate.

4. The method according to claim 1 wherein the instructional material is contained in one of a video, digital format, or a written manual.

5. The method according to claim 1 further comprising querying the second party as to whether it has additional questions as to the instructional material.

6. The method according to claim 5 further comprising providing data to the second party on how to gain further information from one of an information phone center or a website.

7. The method according to claim 1 further including retrieving serial number and safety codes from the second party and entering them into a database.

8. The method according to claim 1 wherein the second party inputs the embedded codes from the instructional materials into a phone center using a telephone's key pad touch tone.

9. The method according to claim 1 wherein the second party enters the value of the embedded code using a telephone key pad.

10. The method according to claim 9 further including comparing the entered value of the embedded code with a known value.

11. The method according to claim 10 further including sending a notification to the second party if the entered value does not equal the known value.

12. A method of ensuring the transfer of safety information in a user manual to a customer comprising the steps of:
providing the customer with a user manual containing an embedded piece of information;
querying the customer as to the value of the embedded piece of information; and
providing the customer a rebate after determining that the embedded information provided by the customer has a proper value.

13. The method according to claim 12 wherein the customer receives the user manual upon the purchasing of a product.

14. The method according to claim 13 wherein the user manual is contained in one of a video, digital format, or a written manual.

15. The method according to claim 12 further comprising querying the customer as to whether the customer has additional questions about the safety information.

16. The method according to claim 15 further comprising providing data to the customer on how to gain further information from one of an information phone center or visit a website; and
determining if the product has been returned prior to providing the customer a rebate, and if product has been returned, preventing providing the customer the rebate.

17. A method of ensuring the transfer of safety information in a user manual to a customer comprising the steps of:
providing the customer with a user manual at the purchase of a product, the user manual containing an embedded piece of information;
querying the customer as to the value of the embedded piece of information; and
providing the customer a rebate after determining that the embedded information provided by the customer has a proper value, wherein the user manual is contained in one of a video, digital information, or a written manual;
querying the customer as to whether the customer has additional questions as to the safety information;
providing data on how to gain further information from one of an information phone center or visit a website; and
determining if the product has been returned prior to providing the customer a rebate, and if product has been returned, preventing providing the customer the rebate.
